(19) United States
(12) Patent Application Publication
(10) Pub. No.: US 2015/0193089 A1
(43) Pub. Date: Jul. 9, 2015

(54) DYNAMIC PRESENTATION SYSTEMS AND METHODS

(71) Applicant: Google Inc., Mountain View, CA (US)

(72) Inventors: Daniel Berlin, North Potomac, MD (US); Daniel Bentley, New York, NY (US)

(73) Assignee: Google Inc., Mountain View, CA (US)

(21) Appl. No.: 13/742,084

(22) Filed: Jan. 15, 2013

(51) Int. Cl. G06F 3/0481

(52) U.S. Cl. CPC G06F 3/0481

(57) ABSTRACT

Modifying or selecting among a plurality of ordered sets of presentation content, or display paths, allows a presentation to be adjusted while a presentation is being given. Collecting and identifying audience feedback determines what presentation content does and does not interest an audience. By modifying or selecting among a plurality of display paths based on audience feedback collected and identified during a presentation, a presentation may be adapted to its audience while the presentation is being given.

### BACKGROUND

Current presentation applications allow a presenter to prepare the content of her presentation, namely slides and notes, in advance of the presentation. However, because the presenter cannot be sure of her audience's response until she delivers the presentation, the presenter risks both including too little information in her slides and appearing ill-informed, and including too much information in her slides and losing the interest of the audience.

These current presentation applications do not typically allow presenters to change content during a presentation. Therefore, in order to adapt to an audience's needs, presenters may skip superfluous slides or discuss subject matter outside the scope of the prepared slides. But, in so doing, these presenters may risk overlooking important material and distracting their audiences. Moreover, in answering audience questions, the presenter may need to toggle back and forth between slides featuring relevant content, wasting time and further distracting the audience.

There is therefore a need for improved presentation applications.

### SUMMARY

Accordingly, the systems and methods described herein relate to selecting content to present to an audience during a presentation. The systems and methods described herein allow a presentation to include multiple display paths and thereby allow the content being presented to be adapted to meet the circumstances of the presentation. The systems and methods described herein further collect audience feedback data to select or modify a display path to follow. The systems and methods described herein may therefore allow a presentation to be adapted to its audience.

In certain aspects, the systems and methods described herein relate to selecting content to be presented. A plurality of slides, each slide comprising content of a presentation, may be provided at a computer processor by a slide database. In some implementations the slide database may store the plurality of slides. The presentation includes a plurality of display paths, each display path containing an ordered subset of the plurality of slides. A path database may provide the plurality of display paths to the computer processor, and in certain implementations may store the plurality of display paths. The computer processor receives audience feedback data and ranks presentation content based on the audience feedback data. The computer processor further ranks each of the plurality of slides based on the presentation content ranking, and selects a display path from the plurality of display paths based on the ranking of one or more of the slides contained within the display path. The computer processor may comprise a communication sensor for receiving audience feedback data, a feedback aggregator for ranking presentation content based on audience feedback data, a scorer for ranking each of the plurality of slides based on the presentation content ranking, and a path selector for selecting a display path from the plurality of display paths based on the audience feedback data and the presentation content contained within the display path. In certain implementations, the computer processor may also comprise a path adjustor, which may generate an additional display path. In some such implementations, an additional display path may be identified while the presentation is being displayed to the audience.

In certain aspects, the systems and methods described herein relate to generating a presentation. A plurality of slides, each slide comprising content of a presentation, is provided at a computer processor. A user is allowed to generate a plurality of display paths for the presentation, each display path containing an ordered subset of the plurality of slides. A user is further allowed to provide an initial ranking of the display paths, and the presentation having a plurality of slides, a plurality of display paths, and a ranking of the display paths is stored. In certain implementations, the computer processor may suggest a display path or an initial ranking of the display paths. In certain implementations, the computer processor may modify display path rankings, in some such implementations based on audience feedback data.

### BRIEF DESCRIPTION OF THE DRAWINGS

The systems and methods described herein are set forth in the appended claims. However, for the purpose of explanation, several implementations are set forth in the following figures.

FIG. 1 is a block diagram of a presentation responsive to audience feedback, according to an illustrative implementation;

FIG. 2 is a block diagram of a presentation content selection system, according to an illustrative implementation;

FIG. 3 is a block diagram of a computing device for performing any of the processes described herein;

FIG. 4 depicts an exemplary screenshot of multiple display paths available in a presentation made with the presentation content selection system of FIG. 2;

FIG. 5A-B depict exemplary presentation slides for identifying a topic an audience wishes to be presented;

FIG. 6 depicts an exemplary interface for providing audience feedback regarding presentation display paths;

FIG. 7 depicts an exemplary user interface for providing audience feedback regarding presentation display paths;

FIG. 8 is a flow chart of a process for identifying a display path, according to an illustrative implementation;

FIG. 9 is a flow chart of a process for selecting a predetermined display path in response to a predetermined condition, according to an illustrative implementation; and

FIG. 10 is a flow chart of a process for adjusting a display path in response to a predetermined condition, according to an illustrative implementation.

### DETAILED DESCRIPTION

In the following description, numerous details are set forth for the purpose of explanation. However, one of ordinary skill in the art will realize that the implementations described herein may be practiced without the use of these specific details and that the implementations described herein may be modified, supplemented, or otherwise altered without departing from the scope of the invention.

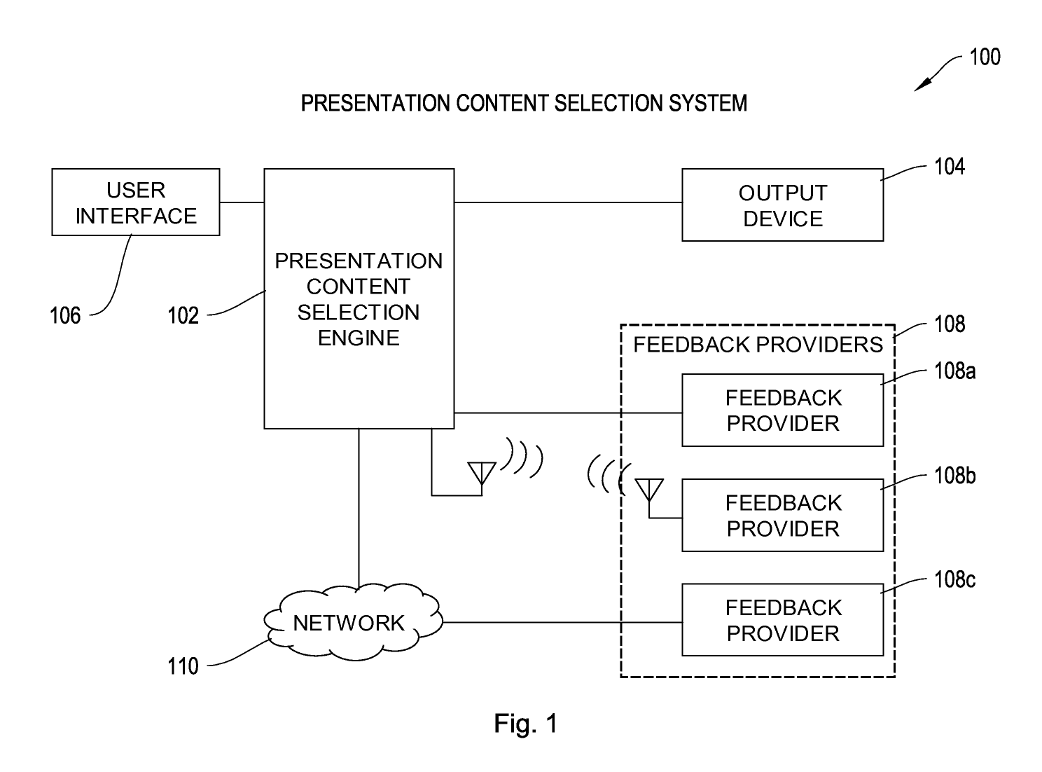

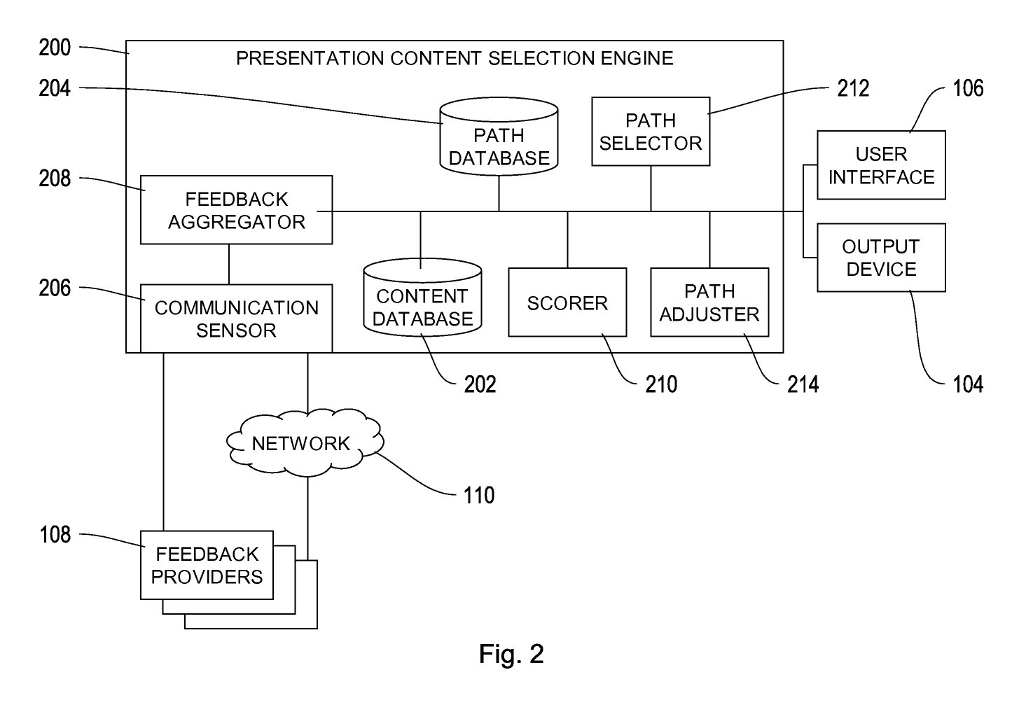

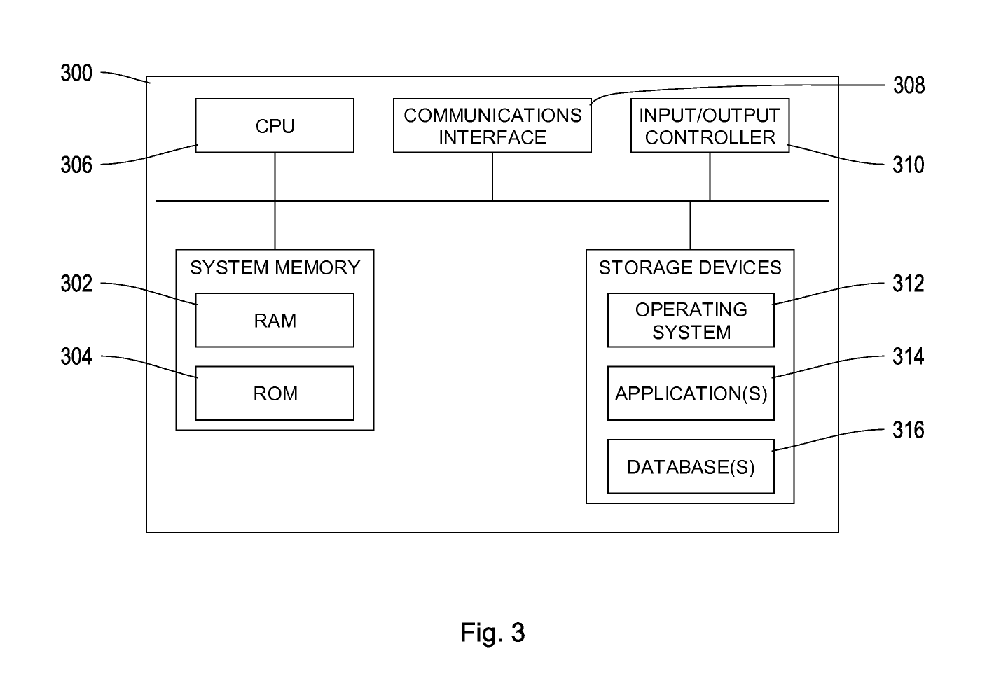

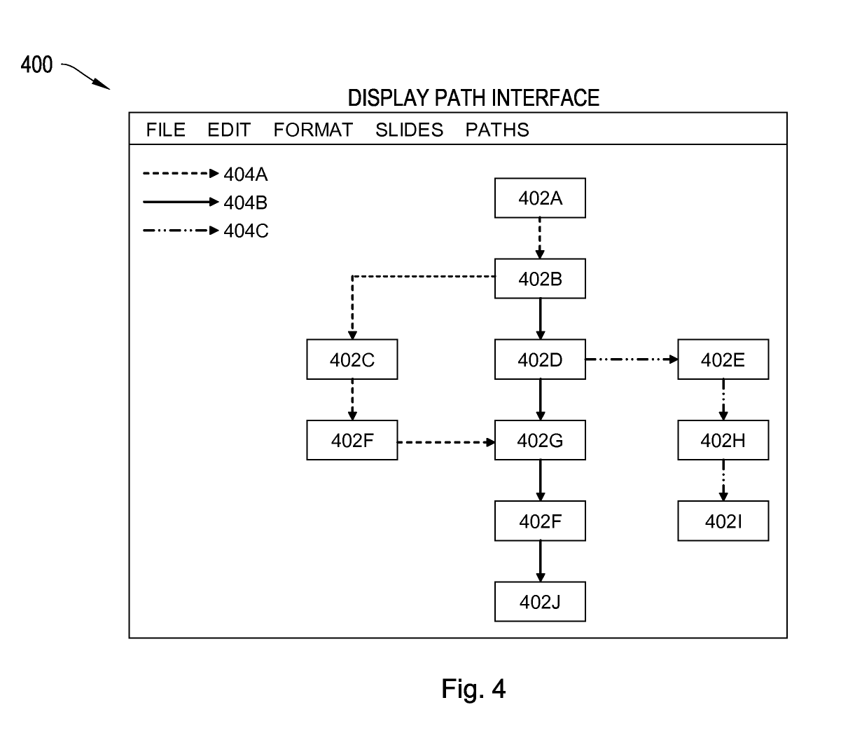

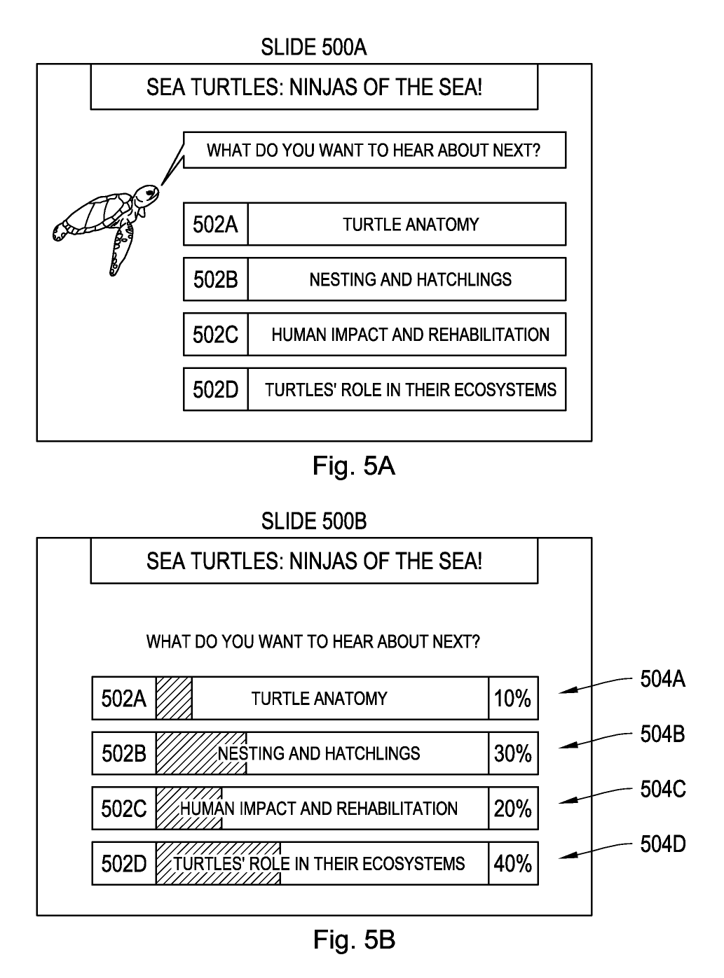

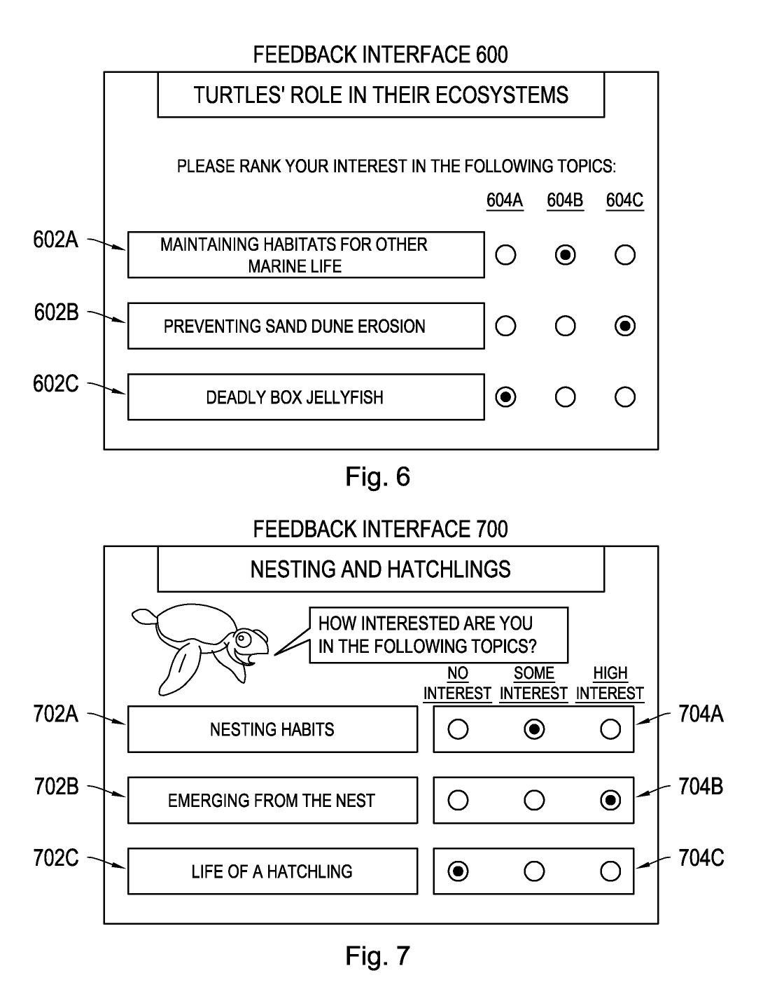

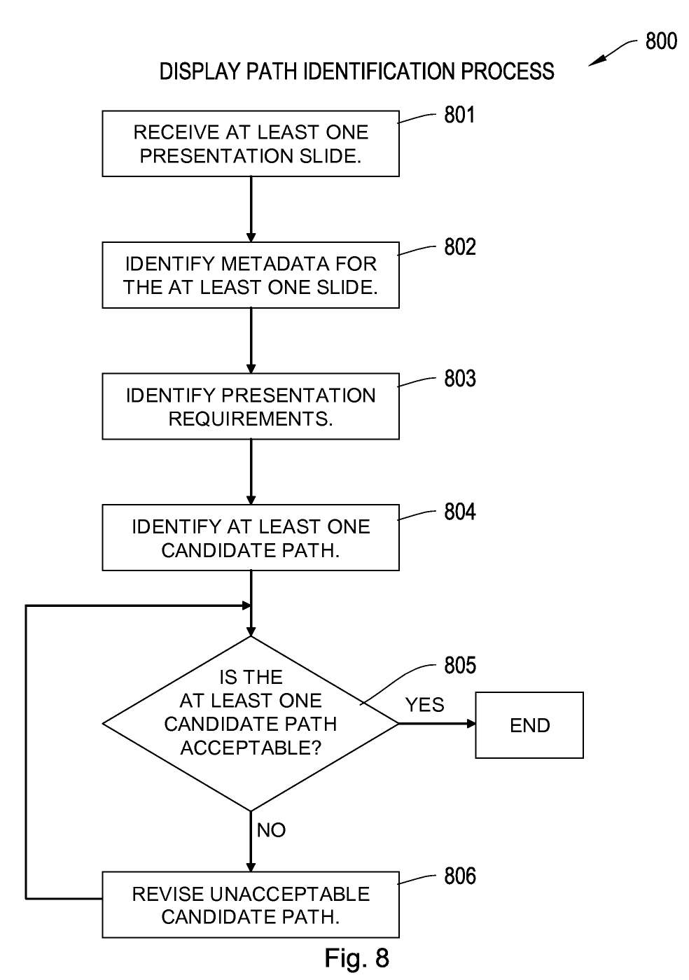

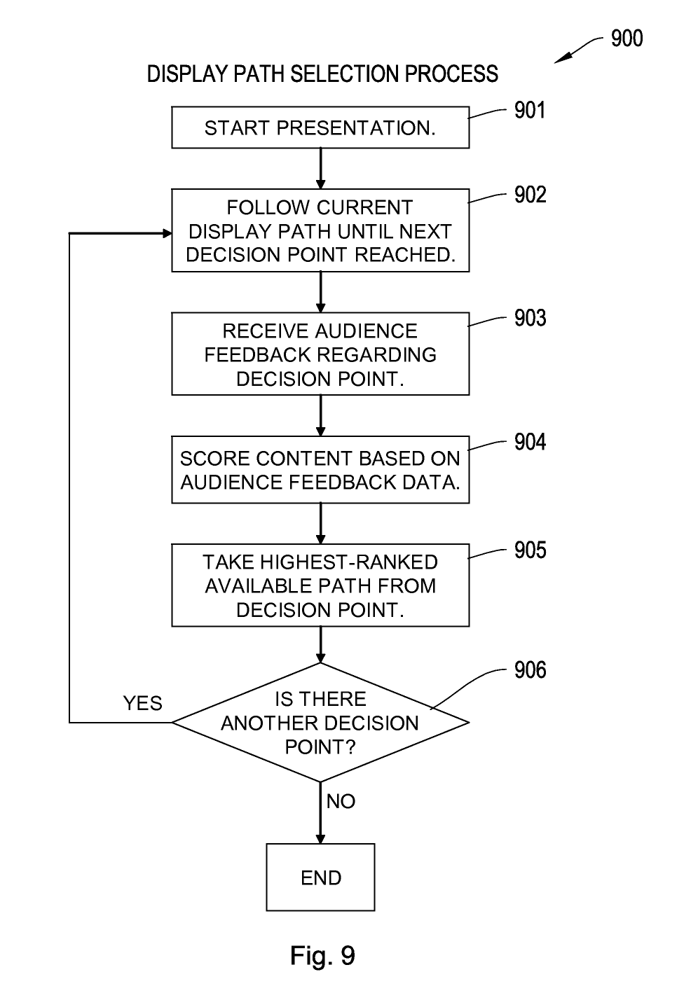

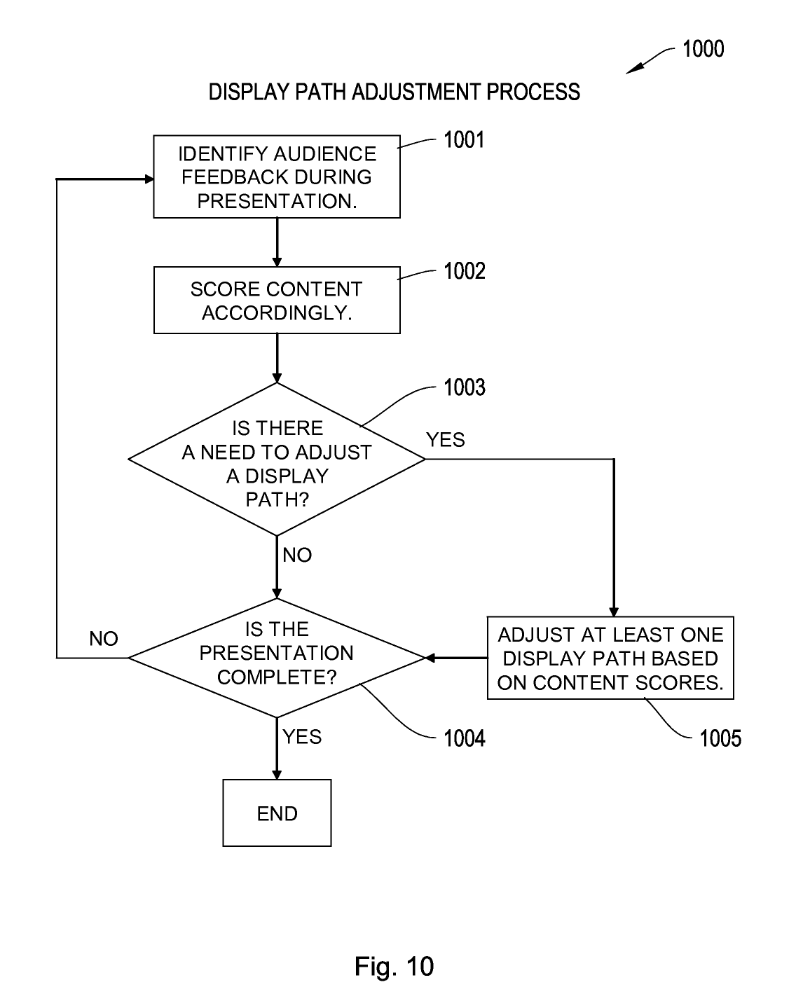

The systems and methods described herein relate to selecting presentation content for display. In response to audience feedback or other suitable criteria, a presentation content selection engine may select or alter a display path of the presentation. FIG. 1 provides an overview of an exemplary system used to provide such content selection. FIG. 2 describes in more detail an exemplary system to receive audience feedback and select a display path. FIG. 3 depicts a block diagram of a computing device that may make up one or more components of the systems described herein. FIG. 4 depicts an exemplary user interface for providing a display path of a presentation. FIG. 5A depicts an exemplary slide soliciting an audience choice of a presentation topic, and FIG. 5B depicts an exemplary slide indicating the response to the slide of FIG. 5A. FIGS. 6 and 7 depict exemplary user interfaces for providing audience feedback regarding predetermined display paths. FIG. 8 provides an exemplary method for generating a display path for a presentation. FIG. 9 provides an exemplary method for selecting from a plurality of display paths during a presentation, and FIG. 10 provides an exemplary method of adjusting a display path during a presentation.

### General System Description

FIG. 1 is an illustrative block diagram of a presentation content selection system 100, which presents an ordered subset of content of a presentation to an audience. The content of a presentation may be presented on a slide, and may include text, images, sound files, video files, hypertext markup language (HTML) links to content, or other media. An ordered subset of slides associated with a presentation is referred to as a display path, and a presentation may include more than one display path. System 100 includes a presentation content selection engine 102, which provides presentation content to output device 104 according to instructions provided through user interface (UI) 106 and in the order indicated by the display path. A display path may be chosen or altered based on audience feedback data gathered from one or more of feedback providers 108a, 108b, and 108c (collectively, feedback providers 108) by presentation content selection engine 102.

Presentation content selection engine 102 may be a computer processor providing presentation content to output device 104 according to a display path. Presentation content selection engine 102 may present content included in a display path in response to commands provided by a presenter through UI 106. As an illustrative example, if a presenter presses a right-arrow button while presenting, presentation content selection engine 102 may provide the next piece of content in the display path to output device 104. Presentation content selection engine 102 may store one or more slides, access one or more slides stored at a remote location, or some combination thereof. Presentation content selection engine 102 may switch between display paths or adjust a display path in response to audience feedback data, which presentation content selection engine 102 may gather from one or more feedback providers 108.

Output device 104 may be a computer monitor, a projector, a webcast, a loudspeaker, or other suitable device for providing a presentation to an audience. Output device 104 receives content from presentation content selection engine 102 through a Digital Visual Interface (DVI) cable, through a network connection, through an audio cable, or through some other suitable connection. Content may include slides of a display path. Output device 104 provides the received content to an audience that may include one or more feedback providers 108.

UI 106 is an interface through which a user may control presentation content selection engine 102, and may include a keyboard, a mouse, a personal computer, a mobile computing device, a remote controller, or other device suitable for providing commands to presentation content selection engine 102. In certain implementations, UI 106 may provide a user with information not provided to output device 104, such as supplemental notes regarding presentation content, an indicator of content that will be presented, or other suitable information. In certain implementations, a user may use UI 106 to alter one or more of presentation content and a presentation path. In some such implementations, the alterations may be made while content is being presented through output device 104. In certain implementations, UI 106 may be integrated with presentation content selection engine 102.

Feedback providers 108a, 108b, and 108c (collectively, feedback providers 108) provide audience feedback data to presentation content selection engine 102. Audience feedback data may include a vote regarding which presentation content should be displayed, an expression of satisfaction or dissatisfaction with a presentation, an expression of interest in a topic, a question regarding the presentation content, or other suitable feedback data. Feedback provider 108a provides feedback to presentation content selection engine 102 through a device connected to presentation content selection engine 102, which may include a computer terminal, a microphone, a camera, or other device suitable for gathering audience feedback data. Feedback provider 108b may wirelessly transmit feedback to presentation content selection engine 102 using a remote controller, a cellular telephone, or through some other suitable transmitting device. Feedback provider 108c may use a personal computer, mobile computing device, or other suitable device to provide feedback through a computer network 110 connected to presentation content selection engine 102. Feedback provided through network 110 may include votes taken on a polling website associated with engine 102, comments posted to a website from which engine 102 may aggregate feedback, or other suitable feedback. In certain implementations, engine 102 may be configured to search for feedback on Internet websites, which may include microblogging or social networking websites.

In certain implementations, a feedback provider 108c need not be an audience member. As an illustrative example of such an implementation, a presentation being given on high-energy physics might have been diverted to a display path regarding the Higgs boson in response to engine 102 identifying a press release regarding the discovery thereof. Similarly, in certain implementations presentation content selection engine 102 may receive audience feedback data before or after a presentation, or may select a display path before the presentation begins. As an illustrative example of such implementations, if a majority of feedback providers 108a entering a lecture hall indicate that they have a technical background, presentation content selection engine 102 may select a display path meant for a more technical audience before the presentation begins.

Presentation content selection system 100 provides presentation content to an audience. Presentation content selection engine 102 provides content to output device 104 in accord with a display path. UI 106 allows a user to move along a display path, allowing a user to control what content is being presented to an audience through output device 104. Feedback providers 108 generate audience feedback data, and may thereby identify which display path presentation content selection engine 102 will follow or indicate how a display path should be adjusted.

### Presentation Content Selection Engine

FIG. 2 is an illustrative block diagram of a presentation content selection engine 200, which may act as the engine 102 of FIG. 1. Presentation content selection engine 200 provides presentation content to output device 104 according to a display path and instructions provided through UI 106, and may change display paths or adjust a display path based on audience feedback data gathered from feedback providers 108. Presentation content is stored in content database 202, and display paths indicating which presentation content to display and in which order are stored in path database 204. Audience feedback data is received by communication sensor 206, and used by feedback aggregator 208 to rank presentation content. Scorer 210 may rank slides stored in content database 202 based on the content ranking made by feedback aggregator 208, and path selector 212 selects a display path from path database 204 based on the different slide rankings generated by scorer 210. Path adjustor 214 may adjust or create a display path in response to audience feedback data, presentation of content earlier during a presentation, a measured passage of time, or other suitable criteria.

Content database 202 may be a computer-readable and -writable medium providing presentation slides associated with a presentation, which may include text, images, audio files, video files, HTML links, or other suitable media. Content database 202 may store slides, provide instructions for accessing remotely stored slides, or otherwise provide slides. In certain implementations, content database 202 may store content not associated with a presentation slide. In such implementations, content may be associated with information regarding slide arrangement, which may include how much space the content would take up on a presentation slide, an abbreviated version of the content that may be placed on a slide, or other information allowing a computer to arrange the content on a slide. Content database 202 may also store metadata regarding slides or content, such as a presentation the slide or content is associated with, a user score or ranking of a slide or content, a relationship between two or more slides or pieces of content, an indication of how long the content or slide takes to present, a slide score generated by scorer 210, or other suitable metadata regarding slides or content.

Path database 204 may be a computer-readable and -writable medium storing at least one display path associated with the presentation. The at least one display path may be an ordered set of slides stored in content database 202, or, in certain implementations, may be an ordered set of content stored in content database 202 and one or more templates for slides featuring the stored content. Path database 204 may also store metadata associated with a display path, such as a presentation the display path is associated with, a relationship between the display path and a second display path, audience feedback data regarding the display path, an amount of time required to present the display path, an indication of optional portions of the display path, or other suitable metadata associated with the display path.

Communication sensor 206 may include an infrared sensor, an Ethernet connection, an Internet search engine, a camera, a microphone, or some other sensor suitable for receiving audience feedback data generated by a feedback provider 108. Communication sensor 206 may receive audience feedback data from a feedback provider 108a or 108b transmitting a signal to engine 200, from a feedback provider 108c transmitting a message to engine 200 through an e-mail or by making a predetermined HyperText Transfer Protocol (HTTP) request, or through some other suitable method for receiving audience feedback data. In certain implementations, communication sensor 206 may also receive audience feedback data not transmitted to engine 200. As illustrative examples of such implementations, communication sensor 206 may record an image or sound of an audience reacting to presentation content, may search one or more websites for posts made by an identified feedback provider 108 or featuring content associated with the presentation, or may otherwise gather audience feedback data without receiving a transmission from the audience. Communication sensor 206 provides the gathered audience feedback data to feedback aggregator 208 for identification.

Feedback aggregator 208 may be a computer processor, and ranks presentation content based on audience feedback data received by communication sensor 206. In certain implementations, feedback aggregator 208 may rank content by assigning a score to content. As an illustrative example of such an implementation, in a presentation regarding reptiles, if content associated with turtles receives twice as much positive feedback as content associated with tortoises, content associated with turtles may be scored twice as highly as content associated with tortoises, and be ranked accordingly. In certain implementations, audience feedback data may identify content that a plurality of audience members wants to be displayed in the presentation, or may identify content that a plurality of audience members wants to be excluded from display in the presentation. As described in relation to FIG. 5, feedback aggregator 208 may rank content using a predetermined function of messages generated by a feedback provider 108 and the content being presented to the feedback provider 108. In certain implementations, feedback aggregator 208 may perform natural language processing on audience feedback data, such as by searching posts gathered by communication sensor 206 for words associated with presentation content and for words establishing a tone. As an illustrative example of such an implementation, were communication sensor 206 to identify a post by a feedback provider 108 stating “I hope Professor Smith talks about Tesla,” feedback aggregator 208 may identify the key words “hope” and “Tesla” to interpret the post as a vote for a display path featuring content regarding Nikola Tesla. Similarly, feedback aggregator 208 may identify an increase in posts made by a feedback provider 108 but unrelated to presentation content as an indication of boredom with the present display path. Such implementations may assign scores to content based on the rate at which feedback providers 108 post positive, negative, or unrelated comments, the number of feedback providers 108 posting positive, negative, or unrelated comments within a predetermined period of time, or through some other function of the number, source, and tone of comments gathered by communication sensor 206. In certain implementations, feedback aggregator 208 may interpret non-textual data. As illustrative examples of such implementations, feedback aggregator 208 may associate changes in ambient noise with changes in audience interest in a topic being presented, may identify what content audience members are or are not looking at by identifying eyes in an image of the audience, or otherwise compare non-textual data to predetermined criteria to identify audience feedback data.

Scorer 210 may be a computer processor for ranking slides stored in content database 202 according to the content ranking performed by feedback aggregator 208. In certain implementations, scorer 210 may rank slides by assigning a score to slides. As an illustrative example of such an implementation, if feedback aggregator 208 assigns a score of one point to a first variety of content and two points to a second variety of content, scorer 210 may assign a slide one point for each item of the first variety included in the slide and two points for each item of the second variety included in the slide. The slides stored in content database 202 may be ranked based on user input or earlier audience feedback when the presentation begins, and scorer 210 may adjust those ranks in response to feedback identified by feedback aggregator 208. As an illustrative example, if feedback aggregator 208 reduces the rank of content being displayed, scorer 210 may reduce the ranking of slides with related content, regardless of whether the slides are featured in the current display path. In certain implementations, rank adjustments generated by scorer 210 may be reversed after the presentation has been completed. Slide ranks, in turn, may affect which display path is selected by path selector 212 or how a display path is changed by path adjustor 214.

Path selector 212 may be a computer processor for selecting a display path stored in path database 204 based on the scores assigned to the content of content database 202. When a presentation can continue down one of at least two display paths, path selector 212 compares the slide rankings associated with the at least two display paths to determine which display path to follow. Path selector 212 may select a display path on the basis of which display path has the highest ranking slide, the highest average slide ranking, the largest cumulative score, or on some other predetermined basis. In certain implementations, path selector 212 may also select a display path based on other predetermined criteria, such as the amount of time available in the presentation and the amount of time a display path is projected to require.

Path adjustor 214 may be a computer processor for adjusting display paths in response to audience feedback, to commands from UI 106, or to some other predetermined condition. In adjusting an existing display path, path adjustor 214 may remove content, replace one item of content with a related item of content, add content, or otherwise alter the display path. Such adjustments may be made in response to a prior display of content, to user feedback, or to some other suitable criteria. In the former case, if an item of content is included in multiple display paths, path adjustor 214 may remove the item from one or more display paths once the item is first provided to output device 104. In certain implementations, such repeated content may be replaced with a predetermined, simplified version of the repeated content. Likewise, if feedback aggregator 208 indicates boredom with present content, path adjustor 214 may simplify or eliminate similar content in current or potential display paths. Conversely, if feedback aggregator 208 indicates interest in present content, path adjustor 214 may add related content to a display path or replace one or more items of related content with more detailed versions of the one or more items. Similarly, in certain implementations path adjustor 214 may add, remove, or replace content from an existing display path based on how much time remains in the presentation. In certain implementations, path adjustor 214 may further generate new display paths entirely.

A new display path may be generated by path adjustor 214 based on content and content scores. In response to at least one predetermined criterion, such as a change of predetermined magnitude in the score of an item of content, an instruction provided through UI 106, feedback aggregator 208 identifying an item of audience feedback data as a question, or some other predetermined criterion, path adjustor 214 may identify a display path consisting of content associated with the at least one criterion. As an illustrative example, in response to feedback aggregator 208 identifying an incoming question as relating to migratory birds, path adjustor 214 may generate a display path comprising one or more items of content associated with the navigational ability of birds. To extend the example, if one of the items of content was displayed earlier, the item may be excluded from the new display path, or may be replaced with similar content featuring a greater or lesser amount of detail. Similar content and the level of detail of content may be identified by user-provided metadata or by another predetermined criterion. In some implementations, the new display path may be based on an existing display path.

Presentation content selection engine 200, in response to instructions provided through UI 106, follows a display path stored in path database 204. Content is provided from content database 202 to output device 104 according to the position along the display path. Communication sensor 206 gathers audience feedback data from feedback providers 108 and provides the audience feedback data to feedback aggregator 208. In response to the feedback, feedback aggregator 208 ranks presentation content, and scorer 210 adjusts slide rankings based on the presentation content rankings Path selector 212 switches display paths based on content scores when the presentation may change display paths. And based on the content provided through output device 104, the response of feedback providers 108, instructions provided through UI 106, the passage of time, or other suitable criteria, path adjustor 214 may adjust an existing display path or create a new display path.

### Computing Device

FIG. 3 is a block diagram of a computing device that can be used to implement or support the any of the components of the system of FIG. 1 or 2, and for performing any of the processes described herein. Presentation content selection engine 200 may be implemented on one or more computing devices 300 having suitable circuitry, and UI 106 and a feedback provider 108 may communicate with presentation content selection engine 102 through one or more computing devices 300 having suitable circuitry. In certain aspects, a plurality of the components of system 100 may be included within one computing device 300. In certain implementations, a component and a storage device may be implemented across several computing devices 300.

The computing device 300 comprises at least one communications interface unit, an input/output controller 310, system memory, and one or more data storage devices. This can support a network connection such as a connection to network 110 in FIG. 1. The system memory includes at least one random access memory (RAM 302) and at least one read-only memory (ROM 304). The memory 304 can support the content database 202 of FIG. 2, for example. All of these elements are in communication with a central processing unit (CPU 306) to facilitate the operation of the computing device 300. The computing device 300 may be configured in many different ways. For example, the computing device 300 may be a conventional standalone computer or alternatively, the functions of computing device 300 may be distributed across multiple computer systems and architectures. In FIG. 3, the computing device 300 may be linked, via network or local network, to other servers or systems.

The computing device 300 may be configured in a distributed architecture, wherein databases and processors are housed in separate units or locations. Some units perform primary processing functions and contain at a minimum a general controller or a processor and a system memory. In distributed architecture implementations, each of these units may be attached via the communications interface unit 308 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM, and TCP/IP.

The CPU 306 comprises a processor, such as one or more conventional microprocessors and one or more supplementary co-processors such as math co-processors for offloading workload from the CPU 306. CPU 306 The CPU 306 is in communication with the communications interface unit 308 and the input/output controller 310, through which the CPU 306 communicates with other devices such as other servers, user terminals, or devices. The communications interface unit 308 and the input/output controller 310 may include multiple communication channels for simultaneous communication with, for example, other processors, servers, or client terminals.

The CPU 306 is also in communication with the data storage device. The data storage device may comprise an appropriate combination of magnetic, optical, or semiconductor memory, and may include, for example, RAM 302, ROM 304, flash drive, an optical disc such as a compact disc, or a hard disk or drive. The CPU 306 and the data storage device each may be, for example, located entirely within a single computer or other computing device; or connected to each other by a communication medium, such as a USB port, serial port cable, a coaxial cable, an Ethernet cable, a telephone line, a radio frequency transceiver, or other similar wireless or wired medium, or combination of the foregoing. For example, the CPU 306 may be connected to the data storage device via the communications interface unit 308. The CPU 306 may be configured to perform one or more particular processing functions.

The data storage device may store, for example, (i) an operating system 312 for the computing device 300; (ii) one or more applications 314 (e.g., computer program code or a computer program product) adapted to direct the CPU 306 in accordance with the systems and methods described here, and particularly in accordance with the processes described in detail with regard to the CPU 306; or (iii) database(s) 316 adapted to store information that may be utilized to store information required by the program. The depicted database 316 can be any suitable database system, including the commercially available Microsoft Access database, and can be a local or distributed database system. The design and development of suitable database systems are described in McGovern et al., A Guide To Sybase and SQL Server, Addison-Wesley (1993).

The operating system 312 and applications 314 may be stored, for example, in a compressed, an uncompiled and an encrypted format, and may include computer program code. The instructions of the program may be read into a main memory of the processor from a computer-readable medium other than the data storage device, such as from the ROM 304 or from the RAM 302. While execution of sequences of instructions in the program causes the CPU 306 to perform the process steps described herein, hard-wired circuitry may be used in place of, or in combination with, software instructions for implementation of the processes of the present disclosure. Thus, the systems and methods described are not limited to any specific combination of hardware and software.

Suitable computer program code may be provided for performing one or more functions in relation to providing content to an audience as described herein. The program also may include program elements such as an operating system 312, a database management system and “device drivers” that allow the processor to interface with computer peripheral devices (e.g., a video display, a keyboard, a computer mouse, etc.) via the input/output controller 310.

The term “computer-readable medium” as used herein refers to any non-transitory medium that provides or participates in providing instructions to the processor of the computing device 300 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying one or more sequences of one or more instructions to the CPU 306 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device 300 (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

As discussed above, a function relating to presenting content can be realized as a software component operating on a conventional data processing system such as a Unix workstation. In that implementation, the function can be implemented as a C language computer program, or a computer program written in any high level language including C++, Fortran, Java or BASIC. See The C++ Programming Language, 2nd Ed., Stroustrup Addision-Wesley. Additionally, in an implementation where microcontrollers or DSPs are employed, the function relating to presenting content can be realized as a computer program written in microcode or written in a high level language and compiled down to microcode that can be executed on the platform employed. The development of such network traffic control systems is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing. Developing code for the DSP and microcontroller systems follows from principles well known in the art.

Some implementations of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some implementations may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some implementations include a computer program product comprising a computer readable medium (media) having instructions stored thereon/in and, when executed (e.g., by a processor), perform methods, techniques, or implementations described herein, the computer readable medium comprising sets of instructions for performing various steps of the methods, techniques, or implementations described herein. The computer readable medium may comprise a storage medium having instructions stored thereon/in which may be used to control, or cause, a computer to perform any of the processes of an implementation. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some implementations different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some implementations include software instructions for controlling both the hardware of the general purpose or specialized computer or microprocessor, and for enabling the computer or microprocessor to interact with a human user and/or other mechanism using the results of an implementation. Such software may include without limitation device drivers, operating systems, and user applications. Ultimately, such computer readable media further includes software instructions for performing implementations described herein. Included in the programming (software) of the general-purpose/specialized computer or microprocessor are software modules for implementing some implementations.

### Display Paths

FIG. 4 depicts an exemplary screenshot of a display path interface 400. Referring to FIG. 2, display path interface 400 is a graphical user interface depicting the contents of a path database 204. In some implementations, display path interface 400 may be accessed through user interface 106. Items of content 402A-J, collectively items of content 402, are contained in one or more of display paths 404A-C, collectively display paths 404. The arrows corresponding to a display path 404 indicate which content is associated with the display path 404 and in which order. Path 404A begins with 402A, proceeds to 402B, and continues to 402C. But at 402B, the presentation content selection engine 200 may respond to audience feedback data by switching to path 404B and proceeding to 402D. From 402D, presentation content selection engine 200 may proceed along path 404B by continuing to 402G, or switch to path 404C and proceed to 402E. Display paths may include both content unique to the display path and content shared with another display path. As depicted, 402C is unique to path 404A and is thus an example of the former, while 402G is an example of the latter. In certain implementations, path adjustor 214 may alter path 404B to skip 402F if the presentation follows path 404A in including 402F.

A display path 404 may be generated or altered by receiving commands from a user, which may include the user drawing, deleting, or redirecting an arrow between two items of content 402. In certain implementations, a user may generate or alter a display path without using display path interface 400, such as by typing a command, uploading an ordered list of display path content to path database 204, or by generating some other predetermined command establishing the content and order of a display path. In certain implementations, path adjustor 214 may generate one or more suggested display paths based on content, formatting, metadata, or other suitable information associated with the content stored in slide database 202. In certain implementations, the user may provide an initial ranking of the display paths, which may include designating a default display path for the presentation. In certain implementations, path selector 212 may suggest an initial ranking of the display paths. In certain implementations, path selector 212 may modify the ranking of the display paths.

### Direct Audience Feedback

FIGS. 5A-B depict exemplary slides of a presentation presented using the system of FIG. 2. In particular, FIG. 5A depicts a slide asking for audience feedback regarding the content to be presented, and FIG. 5B depicts a slide revealing the choices of the audience.

FIG. 5A depicts an exemplary slide 500A requesting audience feedback data. Slide 500A prompts feedback providers 108 to vote for one of four available topics 502A-D for the presentation to cover. Once the slide is presented, feedback aggregator 208 may identify audience feedback according to a predetermined function, as suggested on slide 500A: receiving the message ‘A’ from a feedback provider 108 may be interpreted as a vote for a display path featuring content regarding turtle anatomy, the message ‘B’ as a vote for content regarding nesting and hatchlings, and so on. In certain implementations, a different number of topics 502 may be presented. FIG. 5B depicts an implementation in which the results are displayed to the audience, but in some implementations the results may not be shown to the audience.

FIG. 5B depicts an exemplary slide 500B presenting results of the vote associated with slide 500A. As depicted, topic 502D has received the plurality of votes from feedback providers 108, prompting path selector 212 to select a display path associated with the role of turtles in their ecosystems. As depicted, the content of slide 500B is not predetermined, but may include references 504A-D to data gathered by feedback aggregator 208. In the case depicted by slide 500B, scorer 210 may increase the score of slides associated with topic 502D and thereby cause path selector 212 to select the display path associated with topic 502D. In certain implementations, the results of a direct vote like that depicted in slide 500B may be implemented by path selector 212 without requiring the intermediation of scorer 210.

FIG. 6 depicts an exemplary feedback interface 600 which may be presented to a feedback provider 108 to solicit audience feedback data. Feedback interface 600 may be provided to a feedback provider 108 by pushing data to an application on a mobile computing device, by providing a feedback provider 108 with a Quick Response (QR) Code directing a computing device to a website featuring feedback interface 600, or through some other suitable measure for providing feedback interface 600 to a feedback provider 108. Feedback interface 600 allows a feedback provider 108 to indicate relative interest in topics 602A-C, collectively referred to as topics 602. Radio buttons 604A-C, collectively referred to as radio buttons 604, respectively indicate the highest, medium, and lowest levels of interest. A feedback provider 108 may thus rank topics 602 by how interesting the feedback provider 108 finds each topic 602, allowing scorer 210 to score presentation slides accordingly. Path selector 212 may identify a predetermined display path to follow based on the resulting scores, or path adjustor 214 may adjust an existing display path based on the resulting scores. In certain implementations, there may be a different number of topics 602 or radio buttons 604 than are here depicted.

FIG. 7, like FIG. 6, depicts an exemplary feedback interface 700 which may be presented to a feedback provider 108 to solicit audience feedback data. Feedback interface 700 may be provided to a feedback provider 108 by pushing data to an application on a mobile computing device, by providing a feedback provider 108 with a Quick Response (QR) Code directing a computing device to a website featuring feedback interface 700, or through some other predetermined measure for providing feedback interface 700 to a feedback provider 108. Feedback interface 700 allows a feedback provider 108 to indicate relative interest in topics 702A-C, collectively referred to as topics 702. Radio buttons 704A-C, collectively referred to as radio buttons 704, respectively indicate how interesting feedback provider 108 finds the corresponding topic. A feedback provider 108 may therefore indicate whether one topic is more interesting than another, and scorer 210 may score slides accordingly. Path selector 212 may identify a predetermined display path to follow based on the resulting scores, or path adjustor 214 may adjust an existing display path based on the resulting scores. In certain implementations, there may be a different number of topics 702 or radio buttons 704 than are here depicted.

### Display Path Identification

FIG. 8 is an illustrative flow chart of a display path identification process 800. Display path identification process 800 identifies at least one display path that a presentation may follow, and may also identify criteria for adjusting a display path or choosing between display paths during the presentation. Display path identification process 800 begins with step 801, in which at least one presentation slide for the presentation is identified. Referring to FIG. 2, the at least one presentation slide may be identified by a user through UI 106, which may include the user providing the presentation slide through UI 106 or the user selecting an existing presentation slide from content database 202. Step 802 identifies metadata for the at least one slide, which may include a score, an expected presentation time, associated slides, or other predetermined metadata. Metadata identification may be performed manually by a user through UI 106, or may be a function of the content and formatting of the at least one slide. As an illustrative example of the latter, a presentation slide featuring a large graph may be identified as a high-score slide. In step 803, a user provides presentation requirements through UI 106, which may include the time allotted to the presentation, slides that must be included in the presentation, or other suitable requirements.

Once the slides, the slide metadata, and the presentation requirements have been identified, step 804 identifies at least one candidate display path, which may include path adjustor 214 identifying the at least one candidate display path based on the content and the metadata associated with the at least one slide, or the user identifying the at least one candidate display path in UI 106. Step 805 determines whether the at least one candidate path is acceptable, in some implementations by detecting whether the user has provided a command to change the at least one candidate path through UI 106. If a candidate path is unacceptable, the user may revise the unacceptable candidate path in step 806 and return to step 805; otherwise, the process is complete, and the presentation may be displayed.

### Display Path Selection

FIG. 9 is an illustrative flow chart of a display path selection process 900. Referring to FIG. 4, display path selection process 900 identifies which display path or paths the presentation will follow based on audience feedback data. Referring to FIG. 2, the presentation begins in step 901, when the user generates an instruction to begin the presentation in UI 106 and the first slide of the presentation is provided to output device 104. In step 902, presentation content selection engine 200 proceeds along a current display path until the path reaches a decision point, a point at which the presentation may proceed along one of several display paths. In step 903, communication sensor 206 receives audience feedback data from feedback providers 108, and feedback aggregator 208 determines the nature of the audience feedback. In certain implementations, communication sensor 206 may collect audience feedback data earlier than step 903, and the data collected since the previous decision point was reached may also be provided to feedback aggregator 208.

In step 904, feedback aggregator 208 scores content based on the audience feedback data as described in relation to FIG. 2. In step 905, path selector 212 determines which display path the presentation will follow. The determination made in step 905 may be based on slide scores generated by scorer 210. In certain implementations, the audience feedback data received in step 903 may address alternate display paths directly, in which case step 904 may be bypassed. Step 906 determines whether there is another decision point remaining in the presentation. If so, process 900 repeats from step 902; otherwise the process is complete.

### Display Path Adjustment

FIG. 10 is an illustrative flow chart of a display path adjustment process 1000. Display path adjustment process 1000 may take place during a presentation, and may alter or generate a display path based on audience feedback, timing, or other predetermined criteria. Referring to FIG. 2, process 1000 begins with step 1001, in which communication sensor 206 identifies audience feedback data during a presentation. In step 1002, feedback aggregator 208 ranks content based on the audience feedback data, and scorer 210 may adjust slide rankings accordingly. In step 1003, path adjustor 214 determines whether the display path should be adjusted. Such a need may be identified by a predetermined criterion, such as whether content that appears in a display paths has already been presented, the percentage of positive or negative reaction of feedback providers 108 to some content, a determination that more than some predetermined percentage of feedback providers 108 are not paying attention to the presentation, detection of a question, a command received from UI 106, a calculation that the remaining slides cannot be presented in the amount of time remaining in the presentation, or some other predetermined criterion. If there is no need to adjust the display path, process 1000 continues to step 1004 to determine whether the presentation is complete. If so, process 1000 comes to an end, but process 1000 returns to step 1001 if not. But when step 1003 does identify a need to adjust the display path, process 1000 proceeds from step 1003 to step 1005, in which path adjustor 214 adjusts a display path as described in relation to FIG. 2. In certain implementations, path adjustor 214 may alternatively generate a new display path in step 1005 under predetermined conditions, such as feedback aggregator 208 identifying a question or a user entering a “new display path” command in UI 106. Once the display path is adjusted, process 1000 proceeds to step 1004.

### Alternative Implementations

While various implementations of the present disclosure have been shown and described herein, it will be obvious to those skilled in the art that such implementations are provided by way of example only. Numerous variations, changes, and substitutions will now occur to those skilled in the art without departing from the disclosure. For example, presentation content within slides may be altered in response to audience feedback data, or an all-audio presentation may be modified based on the number of people on a dance floor. It should be understood that various alternatives to the implementations of the disclosure described herein may be employed in practicing the disclosure. An implementation of the systems and methods described herein may be made independently of or combined with another implementation. It is intended that the following claims define the scope of the disclosure and that methods and structures within the scope of these claims and their equivalents be covered thereby.

The method of the present invention may be performed in either hardware, software, or any combination thereof, as those terms are currently known in the art. In particular, the present method may be carried out by software, firmware, or microcode operating on a computer or computers of any type. Additionally, software embodying the present invention may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, the present invention is not limited to any particular platform, unless specifically stated otherwise in the present disclosure.

We claim:

1. A computer-implemented method of selecting content to be presented, the method comprising:
providing, at a computer processor, a plurality of slides, wherein each slide comprises content of a presentation, and wherein the presentation includes a plurality of display paths, each display path containing an ordered subset of the plurality of slides;
receiving, by the computer processor, audience feedback data;
ranking, by the computer processor, presentation content based on the audience feedback data;
ranking, by the computer processor, each of the plurality of slides based on the presentation content ranking; and
selecting, by the computer processor, a display path from the plurality of display paths based on the ranking of one or more of the slides contained within the associated ordered subset.

2. The method of claim 1, further comprising storing the plurality of slides.

3. The method of claim 1, further comprising storing the plurality of display paths.

4. The method of claim 1, further comprising generating an additional display path.

5. The method of claim 4, wherein the additional display path is generated while the presentation is being displayed to the audience.

6. The method of claim 4, wherein the additional display path is based on an existing display path.

7. The method of claim 6, wherein the additional display path excludes slides that have already been presented in the presentation.

8. The method of claim 1, wherein the ranking of one or more slides is further based on a presenter ranking of the one or more slides.

9. The method of claim 1, further comprising displaying the slides of the selected display path.

10. The method of claim 1, further comprising displaying, to a user delivering the presentation, information identifying content of the next slide to be displayed in the presentation.

11. The method of claim 1, wherein the audience feedback data identifies content that a plurality of audience members wants to be displayed in the presentation.

12. The method of claim 1, wherein the audience feedback data identifies content that a plurality of audience members wants to be excluded from display in the presentation.

13. The method of claim 1, wherein the audience feedback data is identified through at least one of a social networking and a microblogging website.

14. The method of claim 1, wherein the audience feedback data is a vote for content to be presented.

15. A system for selecting content to be presented, comprising:
a slide database for providing a plurality of slides, each presentation slide comprising content of a presentation;
a path database for providing a plurality of display paths, each display path containing an ordered subset of the plurality of slides;
a communication sensor for receiving audience feedback data;
a feedback aggregator for ranking presentation content based on audience feedback data;
a scorer for ranking each of the plurality of slides based on the presentation content ranking; and
a path selector for selecting a display path from the plurality of display paths based on the audience feedback data and the presentation content contained within the ordered subset of slides associated with the display path.

16. The system of claim 15, wherein the slide database stores the plurality of slides.

17. The system of claim 15, wherein the path database stores the plurality of display paths.

18. The system of claim 15, further comprising a path adjustor for generating an additional display path.

19. The system of claim 18, wherein the path adjustor may generate the additional display path while the presentation is being presented to the audience.

20. The system of claim 18, wherein the additional display path excludes slides that have already been presented in the presentation.

21. The system of claim 15, wherein the scorer is further configured for ranking one or more slides based on a presenter ranking of the one or more slides.

22. The system of claim 15, further comprising a user interface for providing information identifying content of the next slide to be displayed in the presentation to a user delivering the presentation.

23. The system of claim 15, wherein the audience feedback data identifies content that the plurality of members of the audience wants to be displayed in the presentation.

24. The system of claim 15, wherein the audience feedback data identifies content that the plurality of members of the audience wants to be excluded from display in the presentation.

25. The system of claim 15, wherein the feedback aggregator identifies feedback posted to at least one of a social networking and a microblogging website.

26. The system of claim 15, wherein the audience feedback data is a vote for content to be presented.

27. A computer-implemented method of generating a presentation, the method comprising:
providing, at a computer processor, a plurality of slides, wherein each slide comprises content of a presentation;
allowing a user to generate a plurality of display paths for the presentation, wherein each display path contains an ordered subset of the plurality of slides;
allowing a user to provide an initial ranking of the display paths; and
storing, by the computer processor, the presentation having a plurality of slides, a plurality of display paths, and a ranking of the display paths.

28. The method of claim 27, further comprising suggesting, by the computer processor, at least one display path.

29. The method of claim 27, further comprising suggesting, by the computer processor, the initial ranking of the display paths.

30. The method of claim 27, further comprising modifying, by the computer processor, the ranking of the display paths.

31. The method of claim 30, wherein the ranking of the display paths is modified based on audience feedback data.
